(19) United States
(12) Patent Application Publication
(10) Pub. No.: US 2013/0044814 A1
(43) Pub. Date: Feb. 21, 2013

(54) METHODS AND APPARATUS FOR ADAPTIVE INTERPOLATIVE INTRA BLOCK ENCODING AND DECODING

(71) Applicants: Liwei Guo, Plainsboro, NJ (US); Peng Yin, Ithaca, NY (US); Yunfei Zheng, Plainsboro, NJ (US); Xiaoan Lu, Princeton, NJ (US); Qian Xu, Plainsboro, NJ (US); Joel Sole, Princeton, NJ (US)

(72) Inventors: Liwei Guo, Plainsboro, NJ (US); Peng Yin, Ithaca, NY (US); Yunfei Zheng, Plainsboro, NJ (US); Xiaoan Lu, Princeton, NJ (US); Qian Xu, Plainsboro, NJ (US); Joel Sole, Princeton, NJ (US)

(73) Assignee: THOMSON LICENSING, ISSY DE MOULINEAUX (FR)

(21) Appl. No.: 13/696,514

(22) PCT Filed: May 7, 2011
(86) PCT No.: PCT/US11/00801

§ 371 Date: Nov. 6, 2012

Related U.S. Application Data
(60) Provisional application No. 61/333,075, filed on May 10, 2010.

(51) Int. Cl. H04N 7/32

(52) U.S. Cl. 375/240.12; 375/E07.243

(57) ABSTRACT

Methods and apparatus are provided for adaptive interpolative intra block encoding and decoding. An apparatus includes a video encoder for encoding at least an intra block in a picture by dividing the intra block into at least a first partition and a second partition, and generating predictions of pixels in the second partition by adaptively interpolating reconstructed pixels from the first partition.

### CROSS-REFERENCE TO RELATED APPLICATIONS

This application claims the benefit of U.S. Provisional Application Ser. No. 61/333,075, filed May 10, 2011, which is incorporated by reference herein in its entirety.

### TECHNICAL FIELD

The present principles relate generally to video encoding and decoding and, more particularly, to methods and apparatus for adaptive interpolative intra block encoding and decoding.

### BACKGROUND

The International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”) is the first video coding standard that employs spatial directional prediction for intra coding. Spatial directional prediction for intra coding provides a more flexible prediction framework, thus the coding efficiency is greatly improved over previous standards where intra prediction was done only in the transform domain. In accordance with the MPEG-4 AVC Standard, spatial intra prediction is performed using the surrounding available samples, which are the previously reconstructed samples available at the decoder within the same slice. For luma samples, intra prediction can be done on a 4×4 block basis (denoted as Intra_{—}4×4), an 8×8 block basis (denoted as Intra_{—}8×8) and on a 16×16 macroblock basis (denoted as Intra_{—}16×16). Turning to FIG. 1, MPEG-4 AVC Standard directional intra prediction with respect to a 4×4 block basis (Intra_{—}4×4) is indicated generally by the reference numeral 100. Prediction directions are generally indicated by the reference numeral 110, image blocks are generally indicated by the reference numeral 120, and a current block is indicated by the reference numeral 130. In addition to luma prediction, a separate chroma prediction is performed. There are a total of nine prediction modes for Intra_{—}4×4 and Intra_{—}8×8, four modes for Intra_{—}16×16 and four modes for the chroma component. The encoder typically selects the prediction mode that minimizes the difference between the prediction and original block to be coded. A further intra coding mode, denoted I_PCM, allows the encoder to simply bypass the prediction and transform coding processes. It allows the encoder to precisely represent the values of the samples and place an absolute limit on the number of bits that may be contained in a coded macroblock without constraining decoded image quality.

Turning to FIG. 2, labeling of prediction samples for the Intra_{—}4×4 mode of the MPEG-4 AVC Standard is indicated generally by the reference numeral 200. FIG. 2 shows the samples (in capital letters A-M) above and to the left of the current blocks which have been previously coded and reconstructed and are therefore available at the encoder and decoder to form the prediction.

Turning to FIGS. 3B-J, Intra_{—}4×4 luma prediction modes of the MPEG-4 AVC Standard are indicated generally by the reference numeral 300. The samples a, b, c, . . . , p of the prediction block are calculated based on the samples A-M using the Intra_{—}4×4 luma prediction modes 300. The arrows in FIGS. 3B-J indicate the direction of prediction for each of the Intra_{—}4×4 modes 300. The Intra_{—}4×4 luma prediction modes 300 include modes 0-8, with mode 0 (FIG. 3B, indicated by reference numeral 310) corresponding to a vertical prediction mode, mode 1 (FIG. 3C, indicated by reference numeral 311) corresponding to a horizontal prediction mode, mode 2 (FIG. 3D, indicated by reference numeral 312) corresponding to a DC mode, mode 3 (FIG. 3E, indicated by reference numeral 313) corresponding to a diagonal down-left mode, mode 4 (FIG. 3F, indicated by reference numeral 314) corresponding to a diagonal down-right mode, mode 5 (FIG. 3G, indicated by reference numeral 315) corresponding to a vertical-right mode, mode 6 (FIG. 3H, indicated by reference numeral 316) corresponding to a horizontal-down mode, mode 7 (FIG. 3I, indicated by reference numeral 317) corresponding to a vertical-left mode, and mode 8 (FIG. 3J, indicated by reference numeral 318) corresponding to a horizontal-up mode. FIG. 3A shows the general prediction directions 330 corresponding to each of the Intra_{—}4×4 modes 300.

In modes 3-8, the predicted samples are formed from a weighted average of the prediction samples A-M. Intra_{—}8×8 uses basically the same concepts as the 4×4 predictions, but with a block size 8×8 and with low-pass filtering of the predictors to improve prediction performance.

Turning to FIGS. 4A-D, four Intra_{—}16×16 modes corresponding to the MPEG-4 AVC Standard are indicated generally by the reference numeral 400. The four Intra_{—}16×16 modes 400 includes modes 0-3, with mode 0 (FIG. 4A, indicated by reference numeral 411) corresponding to a vertical prediction mode, mode 1 (FIG. 4B, indicated by reference numeral 412) corresponding to a horizontal prediction mode, mode 2 (FIG. 4C, indicated by reference numeral 413) corresponding to a DC prediction mode, and mode 3 (FIG. 4D, indicated by reference numeral 414) corresponding to a plane prediction mode. Each 8×8 chroma component of an intra coded macroblock is predicted from previously encoded chroma samples above and/or to the left and both chroma components use the same prediction mode. The four prediction modes are very similar to the Intra_{—}16×16, except that the numbering of the modes is different. The modes are DC (mode 0), horizontal (mode 1), vertical (mode 2) and plane (mode 3).

Although intra prediction in the MPEG-4 AVC Standard can exploit some spatial redundancy within a picture, the prediction relies on pixels outside the block being coded. The spatial distance between the pixels serving as predictions (which we call prediction pixels) and the pixels being predicted (which we call predicted pixels) can be relatively large. With a large spatial distance, the correlation between pixels can be low, and the residue signals can be large after prediction, which affects the coding efficiency.

### Horizontal Spatial Prediction Infra Coding

In a first prior art approach, a horizontal spatial prediction intra coding scheme is described where the distance between prediction pixels and predicted pixels can be reduced for coding efficiency improvement. Each 2Nx2N intra coding block is divided into two Nx2N partitions where the first partition includes all the odd columns (i.e., column 1, 3, . . . N-1) and the second partition includes all the even columns (i.e., column 0, 2, . . . N-2). The encoder first encodes the first partition and then the second partition.

The first partition is encoded using traditional spatial directional predictions as presented in the MPEG-4 AVC Standard. A horizontal 6-tap interpolation filter is applied to the reconstructed first partition pixels, and the interpolated pixels are used as the prediction of the pixels in the second partition. Turning to FIG. 5, the prediction structure in horizontal spatial prediction intra coding is indicated generally by the reference numeral 500. The hatched pixels belong to the first partition and the un-hatched pixels belong to the second partition. For a pixel in the second partition (marked as X in the figure, which denotes the predicted pixel), its immediate neighboring pixels are used as the prediction pixels. The reduced spatial distance between prediction pixels and predicted pixels can result in higher prediction accuracy and better coding performance.

In horizontal spatial prediction intra coding, the encoder always uses horizontal interpolation to generate predictions for the second partition. However, the local picture texture may have different orientations, and the direction with the strongest inter-pixel correlation may not be the horizontal direction. Furthermore, the horizontal spatial prediction intra coding uses a fixed interpolation filter that cannot adapt to local image content. As a result, this method is not very efficient in exploiting spatial correlation in some cases.

### SUMMARY

These and other drawbacks and disadvantages of the prior art are addressed by the present principles, which are directed to methods and apparatus for adaptive interpolative intra block encoding and decoding.

According to an aspect of the present principles, there is provided an apparatus. The apparatus includes a video encoder for encoding at least an intra block in a picture by dividing the intra block into at least a first partition and a second partition, and generating predictions of pixels in the second partition by adaptively interpolating reconstructed pixels from the first partition.

According to yet another aspect of the present principles, there is provided a method in a video encoder. The method includes encoding at least an intra block in a picture by dividing the intra block into at least a first partition and a second partition, and generating predictions of pixels in the second partition by adaptively interpolating reconstructed pixels from the first partition.

According to still another aspect of the present principles, there is provided an apparatus. The apparatus includes a video decoder for decoding at least an intra block in a picture by dividing the intra block into at least a first partition and a second partition, and generating predictions of pixels in the second partition by adaptively interpolating reconstructed pixels from the first partition.

According to yet another aspect of the present principles, there is provided a method in a video decoder. The method includes decoding at least an intra block in a picture by dividing the intra block into at least a first partition and a second partition, and generating predictions of pixels in the second partition by adaptively interpolating reconstructed pixels from the first partition.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing MPEG-4 AVC Standard directional intra prediction with respect to a 4×4 block basis (Intra_{—}4×4);

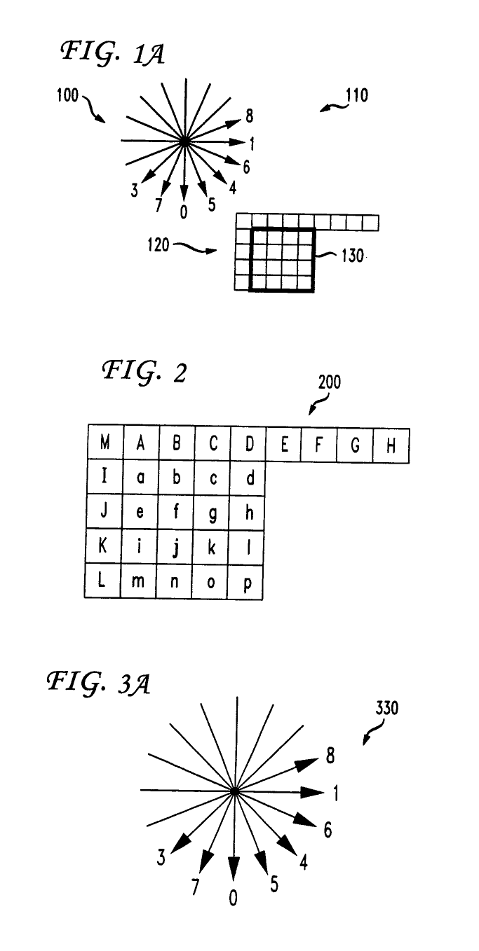

FIG. 2 is a diagram showing labeling of prediction samples for the Intra_{—}4×4 mode of the MPEG-4 AVC Standard;

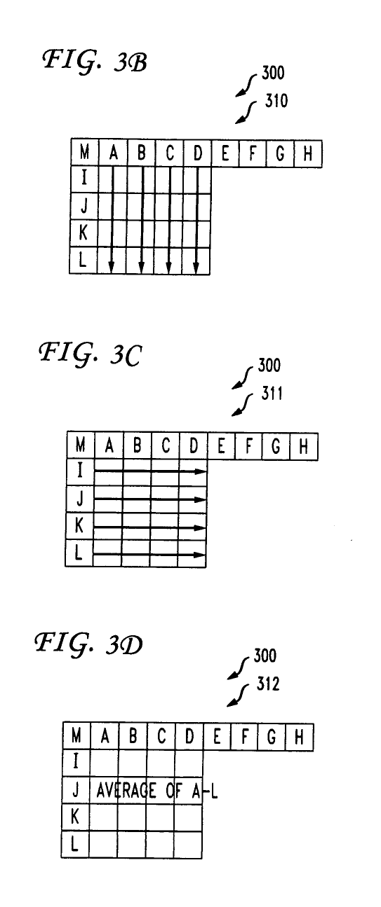

FIGS. 3A-J are diagrams respectively showing Intra_{—}4×4 luma prediction modes of the MPEG-4 AVC Standard;

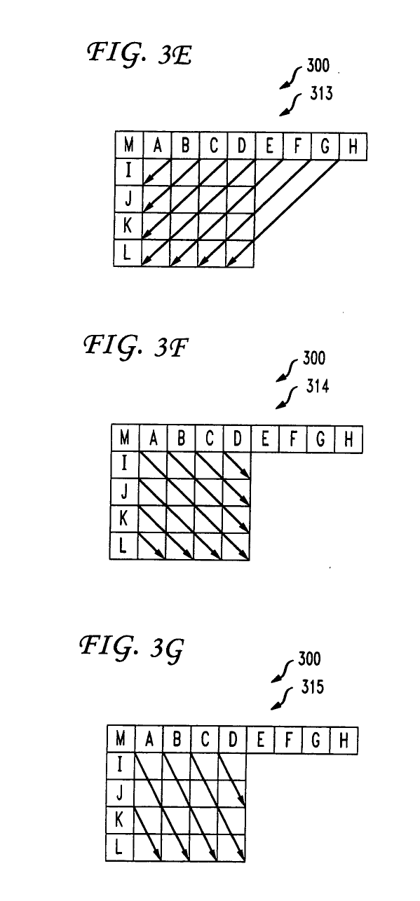

FIGS. 4A-D are diagrams respectively showing four Intra_{—}16×16 modes corresponding to the MPEG-4 AVC Standard;

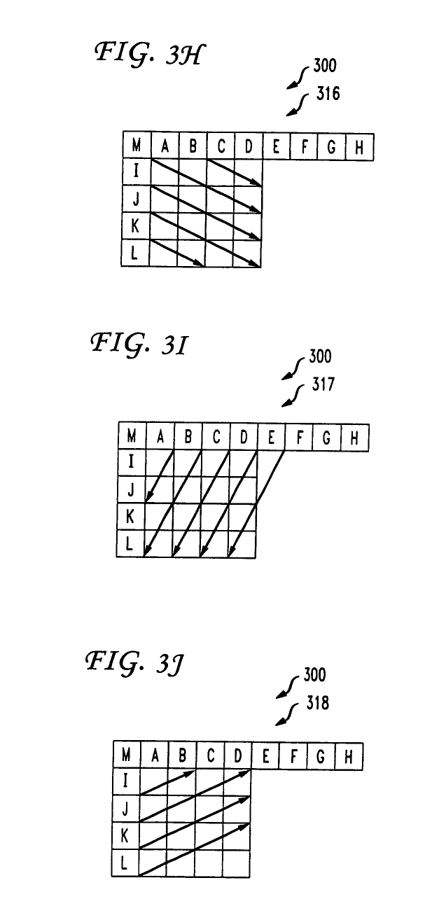

FIG. 5 is a diagram showing the prediction structure in horizontal spatial prediction intra coding to which the present principles may be applied;

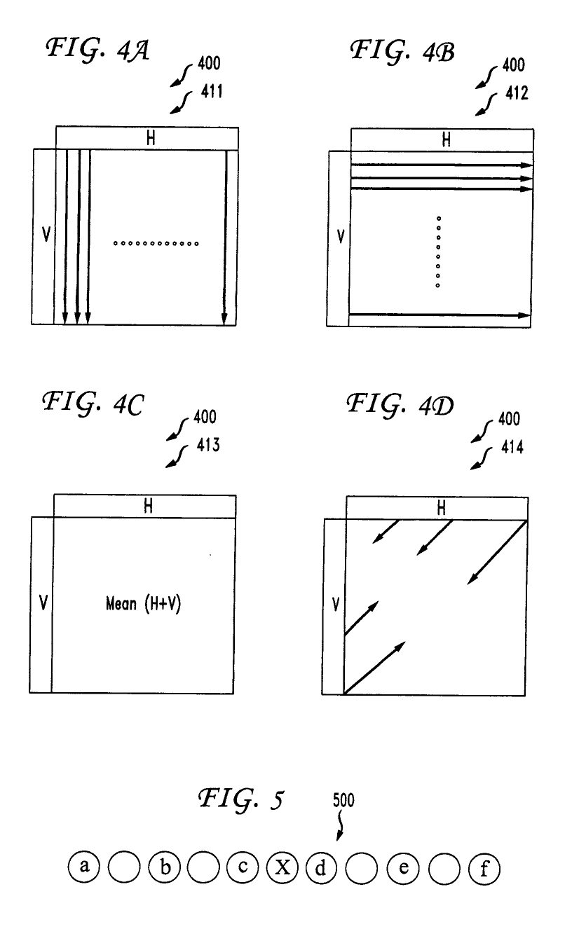

FIG. 6 is a block diagram showing an exemplary video encoder to which the present principles may be applied, in accordance with an embodiment of the present principles;

FIG. 7 is a block diagram showing an exemplary video decoder to which the present principles may be applied, in accordance with an embodiment of the present principles;

FIGS. 8A-C, exemplary pixel partitions are respectively indicated generally by the reference numerals 810, 820, and 830.

FIG. 9 is a flow diagram showing an exemplary method for partitioning pixels in a video encoder, in accordance with an embodiment of the present principles;

FIG. 10 is a flow diagram showing an exemplary method for partitioning pixels in a video decoder, in accordance with an embodiment of the present principles;

FIG. 11 is a flow diagram showing another exemplary method for partitioning pixels in a video encoder, in accordance with an embodiment of the present principles;

FIG. 12 is a flow diagram showing another exemplary method for partitioning pixels in a video decoder, in accordance with an embodiment of the present principles;

FIG. 13 is a flow diagram showing an exemplary method for determining an interpolation direction in a video encoder, in accordance with an embodiment of the present principles;

FIG. 14 is a flow diagram showing an exemplary method for determining an interpolation direction in a video decoder, in accordance with an embodiment of the present principles;

FIG. 15 is a flow diagram showing another exemplary method for determining an interpolation direction in a video encoder, in accordance with an embodiment of the present principles;

FIG. 16 is a flow diagram showing another exemplary method for determining an interpolation direction in a video decoder, in accordance with an embodiment of the present principles;

FIG. 17 is a flow diagram showing yet another exemplary method for determining an interpolation direction in a video encoder, in accordance with an embodiment of the present principles;

FIG. 18 is a flow diagram showing yet another exemplary method for determining an interpolation direction in a video decoder, in accordance with an embodiment of the present principles;

FIG. 19 is a flow diagram showing an exemplary method for deriving an interpolation filter in a video encoder, in accordance with an embodiment of the present principles;

FIG. 20 is a flow diagram showing an exemplary method for deriving an interpolation filter in a video decoder, in accordance with an embodiment of the present principles;

FIG. 21 is a flow diagram showing another exemplary method for deriving an interpolation filter in a video encoder, in accordance with an embodiment of the present principles;

FIG. 22 is a flow diagram showing another exemplary method for deriving an interpolation filter in a video decoder, in accordance with an embodiment of the present principles;

FIG. 23 is a flow diagram showing yet another exemplary method for deriving an interpolation filter in a video encoder, in accordance with an embodiment of the present principles;

FIG. 24 is a flow diagram showing yet another exemplary method for deriving an interpolation filter in a video decoder, in accordance with an embodiment of the present principles;

FIG. 25 is a flow diagram showing still another exemplary method for deriving an interpolation filter in a video encoder, in accordance with an embodiment of the present principles; and

FIG. 26 is a flow diagram showing still another exemplary method for deriving an interpolation filter in a video decoder, in accordance with an embodiment of the present principles.

### DETAILED DESCRIPTION

The present principles are directed to methods and apparatus for adaptive interpolative intra block encoding and decoding.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, for purposes of illustration and description, examples are described herein in the context of improvements over the MPEG-4 AVC Standard, using the MPEG-4 AVC Standard as the baseline for our description and explaining the improvements and extensions beyond the MPEG-4 AVC Standard. However, it is to be appreciated that the present principles are not limited solely to the MPEG-4 AVC Standard and/or extensions thereof. Given the teachings of the present principles provided herein, one of ordinary skill in this and related arts would readily understand that the present principles are equally applicable and would provide at least similar benefits when applied to extensions of other standards, or when applied and/or incorporated within standards not yet developed. It is to be further appreciated that the present principles also apply to video encoders and video decoders that do not conform to standards, but rather confirm to proprietary definitions.

Also, as used herein, the words “picture” and “image” are used interchangeably and refer to a still image or a picture from a video sequence. As is known, a picture may be a frame or a field.

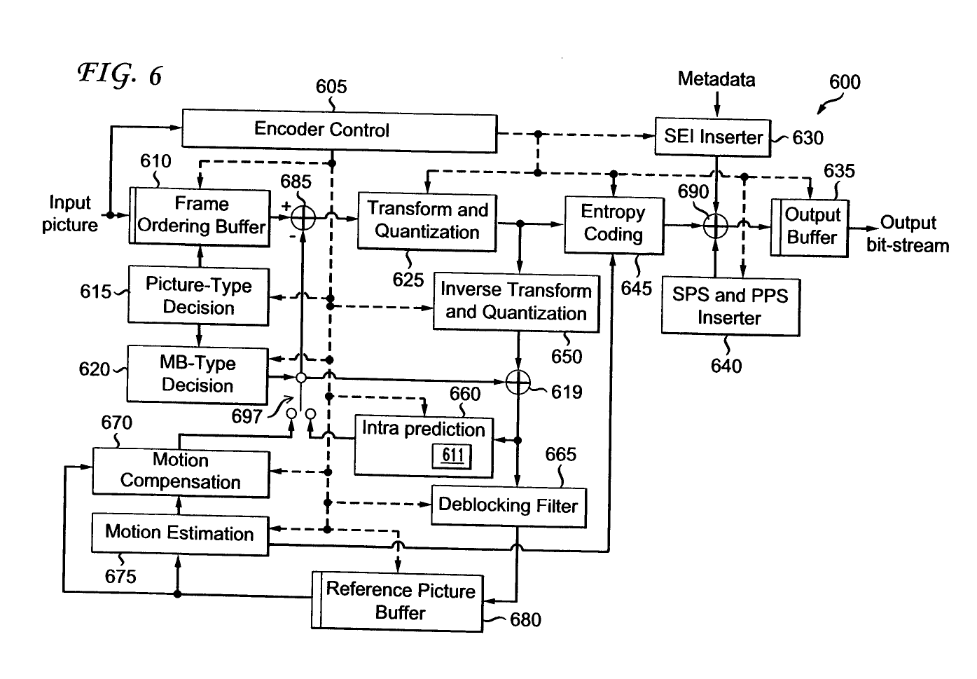

Turning to FIG. 6, an exemplary video encoder to which the present principles may be applied is indicated generally by the reference numeral 600. The video encoder 600 includes a frame ordering buffer 610 having an output in signal communication with a non-inverting input of a combiner 685. An output of the combiner 685 is connected in signal communication with a first input of a transformer and quantizer 625. An output of the transformer and quantizer 625 is connected in signal communication with a first input of an entropy coder 645 and a first input of an inverse transformer and inverse quantizer 650. An output of the entropy coder 645 is connected in signal communication with a first non-inverting input of a combiner 690. An output of the combiner 690 is connected in signal communication with a first input of an output buffer 635.

A first output of an encoder controller 605 is connected in signal communication with a second input of the frame ordering buffer 610, a second input of the inverse transformer and inverse quantizer 650, an input of a picture-type decision module 615, a first input of a macroblock-type (MB-type) decision module 620, a second input of an intra prediction module 660, a second input of a deblocking filter 665, a first input of a motion compensator 670, a first input of a motion estimator 675, and a second input of a reference picture buffer 680.

A second output of the encoder controller 605 is connected in signal communication with a first input of a Supplemental Enhancement Information (SEI) inserter 630, a second input of the transformer and quantizer 625, a second input of the entropy coder 645, a second input of the output buffer 635, and an input of the Sequence Parameter Set (SPS) and Picture Parameter Set (PPS) inserter 640.

An output of the SEI inserter 630 is connected in signal communication with a second non-inverting input of the combiner 690.

A first output of the picture-type decision module 615 is connected in signal communication with a third input of the frame ordering buffer 610. A second output of the picture-type decision module 615 is connected in signal communication with a second input of a macroblock-type decision module 620.

An output of the Sequence Parameter Set (SPS) and Picture Parameter Set (PPS) inserter 640 is connected in signal communication with a third non-inverting input of the combiner 690.

An output of the inverse quantizer and inverse transformer 650 is connected in signal communication with a first non-inverting input of a combiner 619. An output of the combiner 619 is connected in signal communication with a first input of the intra prediction module 660 and a first input of the deblocking filter 665. An output of the deblocking filter 665 is connected in signal communication with a first input of a reference picture buffer 680. An output of the reference picture buffer 680 is connected in signal communication with a second input of the motion estimator 675 and a third input of the motion compensator 670. A first output of the motion estimator 675 is connected in signal communication with a second input of the motion compensator 670. A second output of the motion estimator 675 is connected in signal communication with a third input of the entropy coder 645.

An output of the motion compensator 670 is connected in signal communication with a first input of a switch 697. An output of the intra prediction module 660 is connected in signal communication with a second input of the switch 697. An output of the macroblock-type decision module 620 is connected in signal communication with a third input of the switch 697. The third input of the switch 697 determines whether or not the “data” input of the switch (as compared to the control input, i.e., the third input) is to be provided by the motion compensator 670 or the intra prediction module 660. The output of the switch 697 is connected in signal communication with a second non-inverting input of the combiner 619 and an inverting input of the combiner 685.

A first input of the frame ordering buffer 610 and an input of the encoder controller 605 are available as inputs of the encoder 600, for receiving an input picture. Moreover, a second input of the Supplemental Enhancement Information (SEI) inserter 630 is available as an input of the encoder 600, for receiving metadata. An output of the output buffer 635 is available as an output of the encoder 600, for outputting a bitstream.

It is to be appreciated that in intra prediction module 660, a set adaptive interpolative filters 611 can be used to generate intra prediction signals to encode pixels in the current block. The set of adaptive interpolative filters 611 may include one or more filters, as described in further detail herein below.

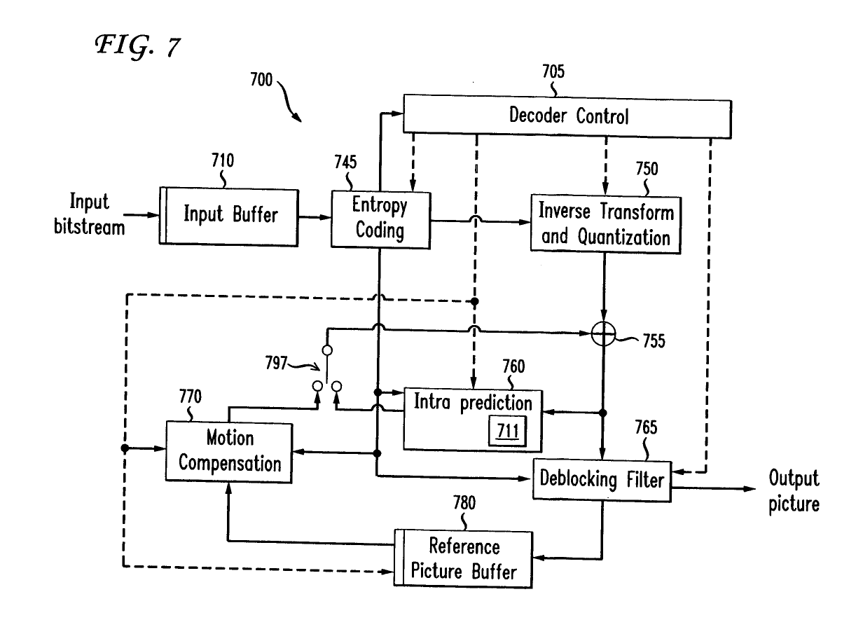

Turning to FIG. 7, an exemplary video decoder to which the present principles may be applied is indicated generally by the reference numeral 700. The video decoder 700 includes an input buffer 710 having an output connected in signal communication with a first input of an entropy decoder 745. A first output of the entropy decoder 745 is connected in signal communication with a first input of an inverse transformer and inverse quantizer 750. An output of the inverse transformer and inverse quantizer 750 is connected in signal communication with a second non-inverting input of a combiner 725. An output of the combiner 725 is connected in signal communication with a second input of a deblocking filter 765 and a first input of an intra prediction module 760. A second output of the deblocking filter 765 is connected in signal communication with a first input of a reference picture buffer 780. An output of the reference picture buffer 780 is connected in signal communication with a second input of a motion compensator 770.

A second output of the entropy decoder 745 is connected in signal communication with a third input of the motion compensator 770, a first input of the deblocking filter 765, and a third input of the intra predictor 760. A third output of the entropy decoder 745 is connected in signal communication with an input of a decoder controller 705. A first output of the decoder controller 705 is connected in signal communication with a second input of the entropy decoder 745. A second output of the decoder controller 705 is connected in signal communication with a second input of the inverse transformer and inverse quantizer 750. A third output of the decoder controller 705 is connected in signal communication with a third input of the deblocking filter 765. A fourth output of the decoder controller 705 is connected in signal communication with a second input of the intra prediction module 760, a first input of the motion compensator 770, and a second input of the reference picture buffer 780.

An output of the motion compensator 770 is connected in signal communication with a first input of a switch 797. An output of the intra prediction module 760 is connected in signal communication with a second input of the switch 797. An output of the switch 797 is connected in signal communication with a first non-inverting input of the combiner 725.

An input of the input buffer 710 is available as an input of the decoder 700, for receiving an input bitstream. A first output of the deblocking filter 765 is available as an output of the decoder 700, for outputting an output picture.

It is to be appreciated that in intra prediction module 760, a set of adaptive interpolative filters 711 can be used to generate intra prediction signals to encode pixels in the current block. The set of adaptive interpolative filters 711 may include one or more filters, as described in further detail herein below.

As noted above, the present principles are directed to methods and apparatus for adaptive interpolative intra block encoding and decoding. Advantageously, the present principles take into account the dominant spatial correlation direction to conduct interpolative predictions, and adaptively determine the coefficients of the interpolation filter.

For an intra block, the method and apparatus divides the pixels into two partitions. The predictions of pixels in the second partition are derived by interpolation using the reconstructed pixels from the first partition. With a much reduced spatial distance between a pixel and its predictions, the prediction accuracy can be improved.

The present principles are at least in part based on the observation that the spatial correlation among pixels often increases when the spatial distance decreases. In a preferred embodiment, the pixels of a 2Nx2M block are divided into two partitions. The encoder selects a spatial intra prediction mode m for the first partition. The first partition is encoded using the traditional method with mode m, and reconstructed. An interpolation filter is applied to the reconstructed pixels in the first partition to generate prediction for the pixels in the second partition. The partition of pixels, interpolation directions and the interpolation filters are adaptively selected to maximize the coding performance. In accordance with the present principles, the pixels serving as predictions (called prediction pixels) include immediate neighboring pixels of the pixels being predicted (called predicted pixels), and thus the prediction accuracy can be very high.

### Partitioning of Pixels

In accordance with the present principles, we disclose and describe methods and apparatus for adaptive partitioning of pixels. The partitioning can be either implicitly derived from a spatial intra prediction mode, or in the alternative, can be explicitly signaled from a set of predefined partitions.

### Embodiment 1:

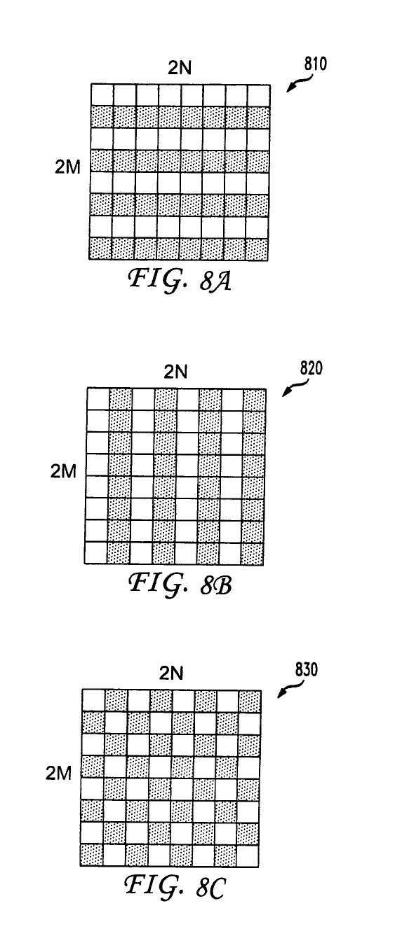

In Embodiment 1, the encoder adaptively divides the pixels in a 2Nx2M block into two partitions. Turning to FIGS. 8A-C, exemplary pixel partitions are respectively indicated generally by the reference numerals 810, 820, and 830. Hatched pixels belong to partition 1, and un-hatched pixels belong to partition 2. These exemplary pixel partitions 810, 820, and 830 are described in further detail herein below.

The partition method is a function of the selected spatial intra prediction mode m for the first partition, and decoder can automatically infer the partition method for block decoding from m. An example is given as follows:
When m is the spatial vertical prediction mode (e.g. mode 0 in intra 4×4 of the MPEG-4 AVC Standard) or nearly spatial vertical prediction mode (e.g., mode 3, 5 and 7 in intra 4×4 of the MPEG-4 AVC Standard), partition 1 includes all the pixels in odd rows (row 1, 3, . . . , 2M-1), and partition 2 includes all the pixels in even columns (row 0, 2, . . . , 2M-2);
2. When m is the spatial horizontal prediction mode (e.g., mode 1 in intra 4×4 of the MPEG-4 AVC Standard) or nearly spatial horizontal prediction mode (e.g., mode 4, 6 and 8 in intra 4×4 of the MPEG-4 AVC Standard), partition 1 includes all the pixels in odd columns (column 1, 3, . . . , 2N-1), and partition 2 includes all the pixels in even columns (column 0, 2, . . . , 2N-2);
3. When m is DC mode, partition 1 includes all the pixels with coordinates (i,j), where (i+j) is an odd number, and partition 2 includes all the other pixels.

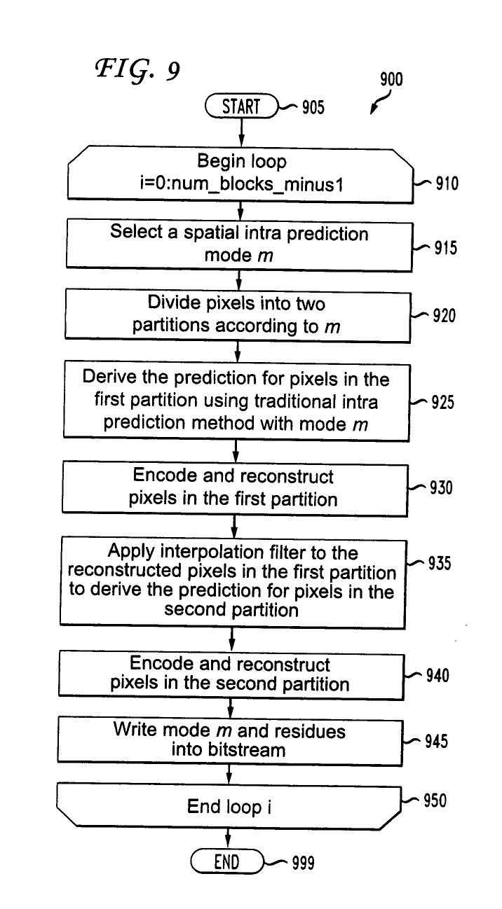

Turning to FIG. 9, an exemplary method for partitioning pixels in a video encoder is indicated generally by the reference numeral 900. The method 900 corresponds to Embodiment 1 relating to the partitioning of pixels. The method 900 includes a start block 905 that passes control to a loop limit block 910. The loop limit block 910 begins a loop using a variable i having a range from 0 to num_blocks_minus1, and passes control to a function block 915. The function block 915 selects a spatial intra prediction mode m, and passes control to a function block 920. The function block 920 divides pixels into two partitions according to m, and passes control to a function block 925. The function block 925 derives the prediction for pixels in the first partition using the traditional intra prediction method with mode m, and passes control to a function block 930. The function block 930 encodes and reconstructs pixels in the first partition, and passes control to a function block 935. The function block 935 applies an interpolation filter to the reconstructed pixels in the first partition to derive the prediction for pixels in the second partition, and passes control to a function block 940. The function block 940 encodes and reconstructs pixels in the second partition, and passes control to a function block 945. The function block 945 writes mode m and the residues into a bitstream, and passes control to a loop limit block 950. The loop limit block 950 ends the loop, and passes control to an end block 999.

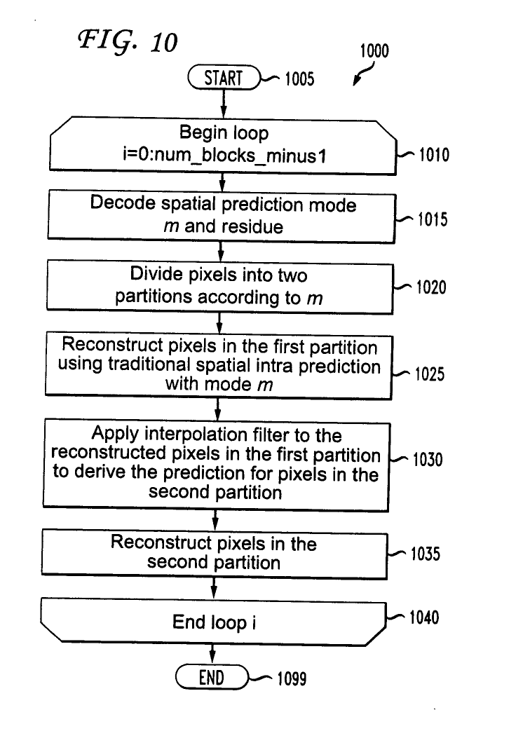

Turning to FIG. 10, an exemplary method for partitioning pixels in a video decoder is indicated generally by the reference numeral 1000. The method 1000 corresponds to Embodiment 1 relating to the partitioning of pixels. The method 1000 includes a start block 1005 that passes control to a loop limit block 1010. The loop limit block 1010 begins a loop using a variable i having a range from 0 to num_blocks_minus1, and passes control to a function block 1015. The function block 1015 decodes a spatial prediction mode m and residues, and passes control to a function block 1020. The function block 1020 divides pixels into two partitions according to m, and passes control to a function block 1025. The function block 1025 reconstructs pixels in the first partition using traditional spatial intra prediction with mode m, and passes control to a function block 1030. The function block 1030 applies an interpolation filter to the reconstructed pixels in the first partition to derive the prediction for pixels in the second partition, and passes control to a function block 1035. The function block 1035 reconstructs pixels in the second partition, and passes control to a loop limit block 1040. The loop limit block 1040 ends the loop, and passes control to an end block 1099.

### Embodiment 2:

In Embodiment 2, the encoder adaptively divides the pixels in a 2Nx2M block into two partitions. Referring again to FIGS. 8A-C, exemplary partition schemes 810, 820, and 830 are shown. The encoder tests different partition methods, and selects the best one based on rate-distortion (RD) criterion. Let partition_idx be index of the partition method selected. For example:

partition_idx=0:
partition 1 includes all the pixels in odd rows (row 1, 3, . . . 2M-1), and partition 2 includes all the pixels in even columns (row 0, 2, . . . 2M-2).

partition_idx=1:
partition 1 includes all the pixels in odd columns (column 1, 3, . . . 2N-1), and partition 2 includes all the pixels in even columns (column 0, 2, . . . 2N-2).

partition_idx=2:
partition 1 includes all the pixels with coordinates (i,j), where (i+j) is an odd number, and partition 2 includes all the other pixels.

The encoder includes the index partition_idx as explicit information (either included in the bitstream or in some other manner conveyed to the decoder, that is either in-band or out-of-band) to indicate its selection. The decoder decodes partition_idx to select the partition method for block decoding.

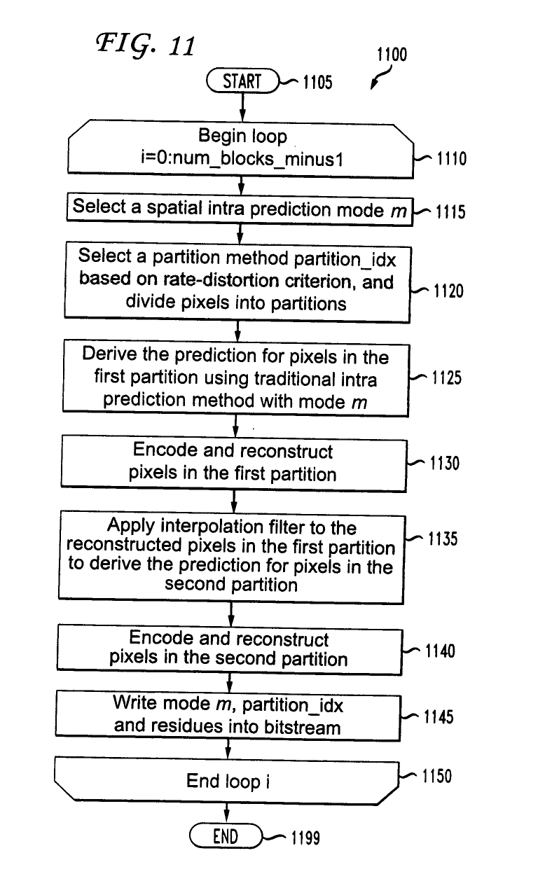

Turning to FIG. 11, another exemplary method for partitioning pixels in a video encoder is indicated generally by the reference numeral 1100. The method 1100 corresponds to Embodiment 2 relating to the partitioning of pixels. The method 1100 includes a start block 1105 that passes control to a loop limit block 1110. The loop limit block 1110 begins a loop using a variable i having a range from 0 to num_blocks_minus1, and passes control to a function block 1115. The function block 1115 selects a spatial intra prediction mode m, and passes control to a function block 1120. The function block 1120 selects a partition method partition_idx based on rate-distortion criteria, divides pixels into two partitions, and passes control to a function block 1125. The function block 1125 derives the prediction for pixels in the first partition using the traditional intra prediction method with mode m, and passes control to a function block 1130. The function block 1130 encodes and reconstructs pixels in the first partition, and passes control to a function block 1135. The function block 1135 applies an interpolation filter to the reconstructed pixels in the first partition to derive the prediction for pixels in the second partition, and passes control to a function block 1140. The function block 1140 encodes and reconstructs pixels in the second partition, and passes control to a function block 1145. The function block 1145 writes mode m, partition_idx, and the residues into a bitstream, and passes control to a loop limit block 1150. The loop limit block 1150 ends the loop, and passes control to an end block 1199.

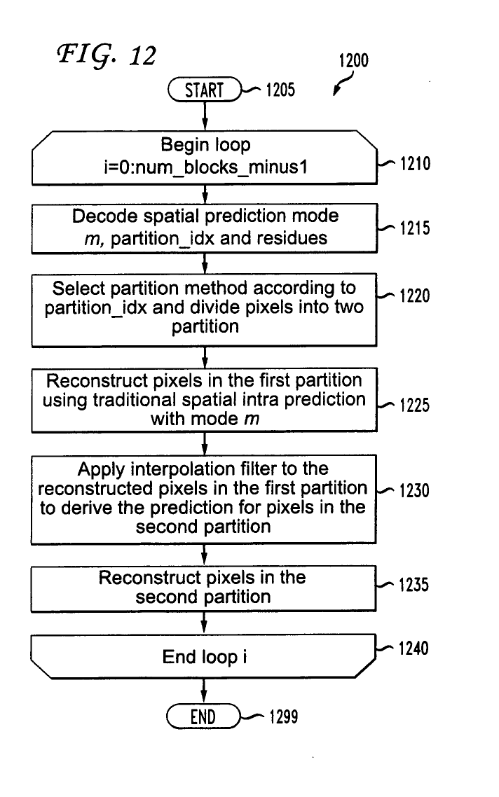

Turning to FIG. 12, another exemplary method for partitioning pixels in a video decoder is indicated generally by the reference numeral 1200. The method 1200 corresponds to Embodiment 2 relating to the partitioning of pixels. The method 1200 includes a start block 1205 that passes control to a loop limit block 1210. The loop limit block 1210 begins a loop using a variable i having a range from 0 to num_blocks_minus1, and passes control to a function block 1215. The function block 1215 decodes a spatial prediction mode m, partition_idx, and residues, and passes control to a function block 1220. The function block 1220 selects a partition method according to partition_idx, divides pixels into two partitions, and passes control to a function block 1225. The function block 1225 reconstructs pixels in the first partition using traditional spatial intra prediction with mode m, and passes control to a function block 1230. The function block 1230 applies an interpolation filter to the reconstructed pixels in the first partition to derive the prediction for pixels in the second partition, and passes control to a function block 1235. The function block 1235 reconstructs pixels in the second partition, and passes control to a loop limit block 1240. The loop limit block 1240 ends the loop, and passes control to an end block 1299.

### Interpolation Direction

In accordance with the present principles, we disclose and describe alternative embodiments in which the interpolation direction can be derived from the partition method, the spatial intra prediction mode, or explicitly signaled based on a predefined set.

### Embodiment 1:

In Embodiment 1, the encoder adaptively selects an interpolation direction for the second partition. The possible direction includes horizontal, vertical, and diagonal with different angles. The interpolation function can be a function of the partition methods, and the decoder can automatically infer the interpolation method from the partition method. An example is given as follows:
1. When the partition method is as shown in FIG. 8A, i.e., partition 1 includes all the pixels in odd rows, and partition 2 includes all the pixels in even rows, vertical interpolation is used.
2. When the partition method is as shown in FIG. 8B, i.e., partition 1 includes all the pixels in odd columns, and partition 2 includes all the pixels in even columns, horizontal interpolation is used.
3. When the partition method is as shown in FIG. 8C, i.e., partition 1 includes all the pixels with coordinates (i,j), where (i+j) is an odd number, and partition 2 includes all the other pixels, an isotropic interpolation is used.

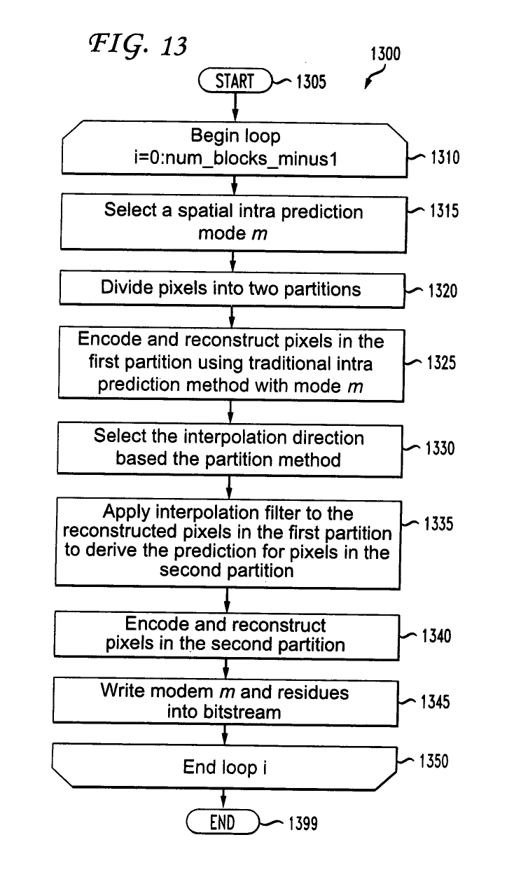

Turning to FIG. 13, an exemplary method for determining an interpolation direction in a video encoder is indicated generally by the reference numeral 1300. The method 1300 corresponds to Embodiment 1 relating to the interpolation direction. The method 1300 includes a start block 1305 that passes control to a loop limit block 1310. The loop limit block 1310 begins a loop using a variable i having a range from 0 to num_blocks_minus1, and passes control to a function block 1315. The function block 1315 selects a spatial intra prediction mode m, and passes control to a function block 1320. The function block 1320 divides pixels into two partitions, and passes control to a function block 1325. The function block 1325 encodes and reconstructs pixels in the first partition using the traditional intra prediction method with mode m, and passes control to a function block 1330. The function block 1330 selects the interpolation direction based on the partition method, and passes control to a function block 1335. The function block 1335 applies an interpolation filter to the reconstructed pixels in the first partition to derive the prediction for pixels in the second partition, and passes control to a function block 1340. The function block 1340 encodes and reconstructs pixels in the second partition, and passes control to a function block 1345. The function block 1345 writes mode m and the residues into a bitstream, and passes control to a loop limit block 1350. The loop limit block 1350 ends the loop, and passes control to an end block 1399.

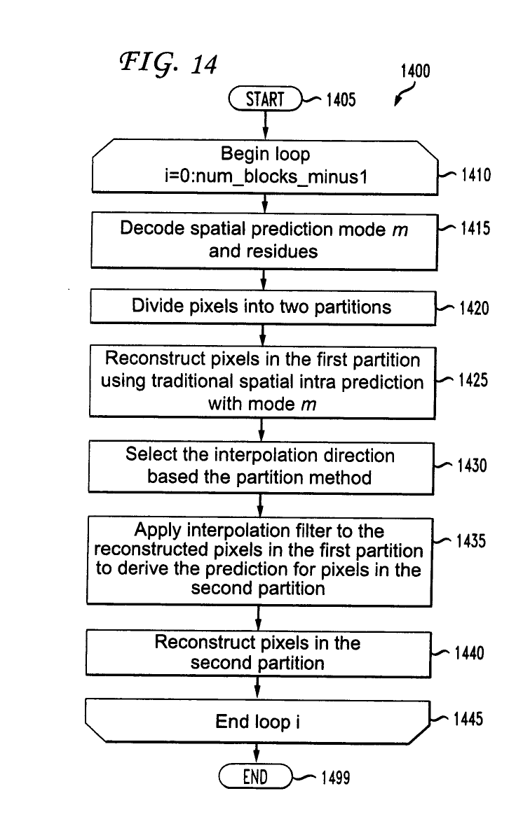

Turning to FIG. 14, an exemplary method for determining an interpolation direction in a video decoder is indicated generally by the reference numeral 1400. The method 1400 corresponds to Embodiment 1 relating to the interpolation direction. The method 1400 includes a start block 1405 that passes control to a loop limit block 1410. The loop limit block 1410 begins a loop using a variable i having a range from 0 to num_blocks_minus1, and passes control to a function block 1415. The function block 1415 decodes a spatial prediction mode m and residues, and passes control to a function block 1420. The function block 1420 divides pixels into two partitions, and passes control to a function block 1425. The function block 1425 reconstructs pixels in the first partition using traditional spatial intra prediction with mode m, and passes control to a function block 1430. The function block 430 selects the interpolation direction based on the partition method, and passes control to a function block 1435. The function block 1435 applies an interpolation filter to the reconstructed pixels in the first partition to derive the prediction for pixels in the second partition, and passes control to a function block 1440. The function block 1440 reconstructs pixels in the second partition, and passes control to a loop limit block 1445. The loop limit block 1445 ends the loop, and passes control to an end block 1499.

### Embodiment 2:

In Embodiment 2, the encoder adaptively selects an interpolation direction for the second partitions. The possible direction includes horizontal, vertical, and diagonal with different angles. The interpolation direction can be a function of the selected spatial intra prediction mode m for the first partition, and the decoder can automatically infer the interpolation direction for block decoding from m. An example is given as follows:
1. When m is the spatial vertical prediction mode (e.g. mode 0 in intra 4×4 of the MPEG-4 AVC Standard) or nearly spatial vertical prediction mode (e.g., mode 3, 5 and 7 in intra 4×4 of the MPEG-4 AVC Standard), horizontal interpolation is used;
2. When m is the spatial horizontal prediction mode (e.g., mode 1 in intra 4×4 of the MPEG-4 AVC Standard) or nearly spatial horizontal prediction mode (e.g., mode 4, 6 and 8 in intra 4×4 of the MPEG-4 AVC Standard), vertical interpolation is used;
3. When m is DC mode, an isotropic interpolation filter is used.

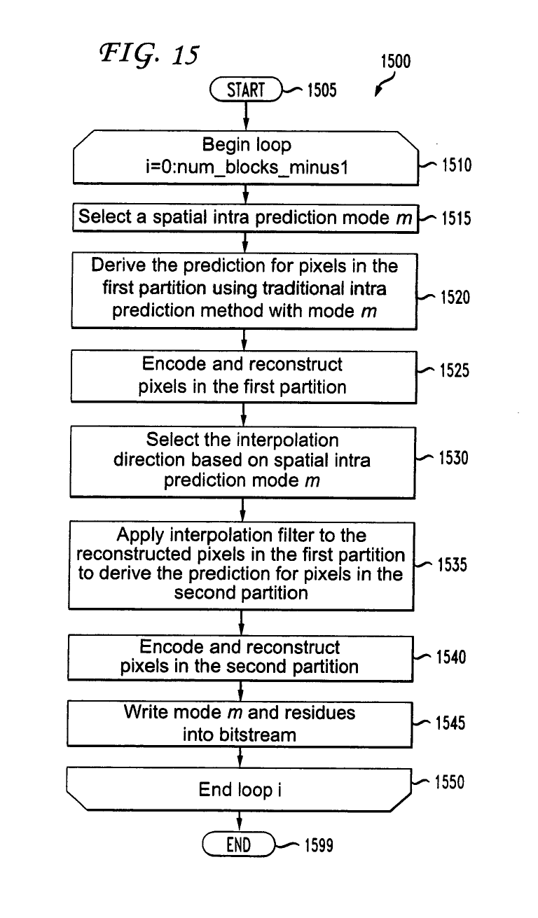

Turning to FIG. 15, another exemplary method for determining an interpolation direction in a video encoder is indicated generally by the reference numeral 1500. The method 1500 corresponds to Embodiment 2 relating to the interpolation direction. The method 1500 includes a start block 1505 that passes control to a loop limit block 1510. The loop limit block 1510 begins a loop using a variable i having a range from 0 to num_blocks_minus1, and passes control to a function block 1515. The function block 1515 selects a spatial intra prediction mode m, and passes control to a function block 1520. The function block 1520 derives the prediction for pixels in the first partition using the traditional intra prediction method with mode m, and passes control to a function block 1525. The function block 1525 encodes and reconstructs pixels in the first partition, and passes control to a function block 1530. The function block 1530 selects the interpolation direction based on the spatial intra prediction mode m, and passes control to a function block 1535. The function block 1535 applies an interpolation filter to the reconstructed pixels in the first partition to derive the prediction for pixels in the second partition, and passes control to a function block 1540. The function block 1540 encodes and reconstructs pixels in the second partition, and passes control to a function block 1545. The function block 1545 writes mode m and the residues into a bitstream, and passes control to a loop limit block 1550. The loop limit block 1550 ends the loop, and passes control to an end block 1599.

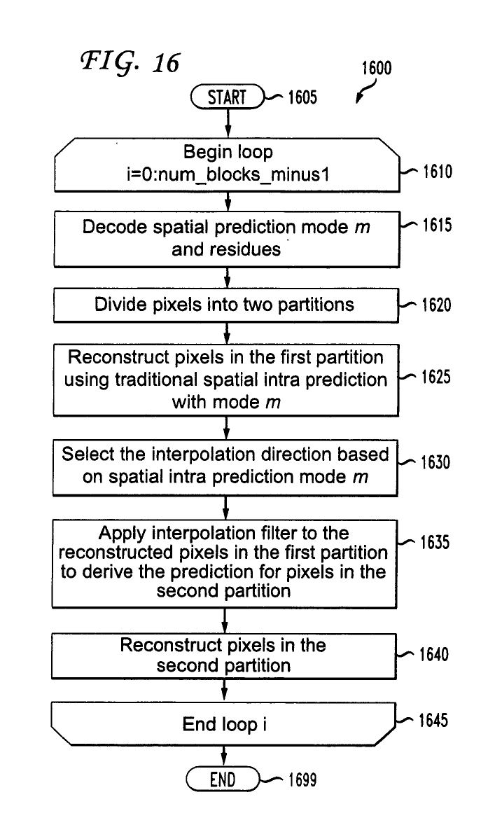

Turning to FIG. 16, another exemplary method for determining an interpolation direction in a video decoder is indicated generally by the reference numeral 1600. The method 1600 corresponds to Embodiment 2 relating to the interpolation direction. The method 1600 includes a start block 1605 that passes control to a loop limit block 1610. The loop limit block 1610 begins a loop using a variable i having a range from 0 to num_blocks_minus1, and passes control to a function block 1615. The function block 1615 decodes a spatial prediction mode m and residues, and passes control to a function block 1620. The function block 1620 divides pixels into two partitions, and passes control to a function block 1625. The function block 1625 reconstructs pixels in the first partition using traditional spatial intra prediction with mode m, and passes control to a function block 1630. The function block 1630 selects the interpolation direction based on the spatial intra prediction mode m, and passes control to a function block 1635. The function block 1635 applies an interpolation filter to the reconstructed pixels in the first partition to derive the prediction for pixels in the second partition, and passes control to a function block 1640. The function block 1640 reconstructs pixels in the second partition, and passes control to a loop limit block 1645. The loop limit block 1645 ends the loop, and passes control to an end block 1699.

### Embodiment 3:

In Embodiment 3, the encoder adaptively selects an interpolation direction for the second partition. The possible direction includes horizontal, vertical, and diagonal with different angles. The encoder tests different directions, and selects the best one based on rate-distortion criterion. Let interp_dir_idx be the index of the selected interpolation direction. The encoder sends the index interp_dir_idx to the decoder to indicate its selection. The decoder decodes interp_dir_idx and accordingly selects the interpolation direction for block decoding.

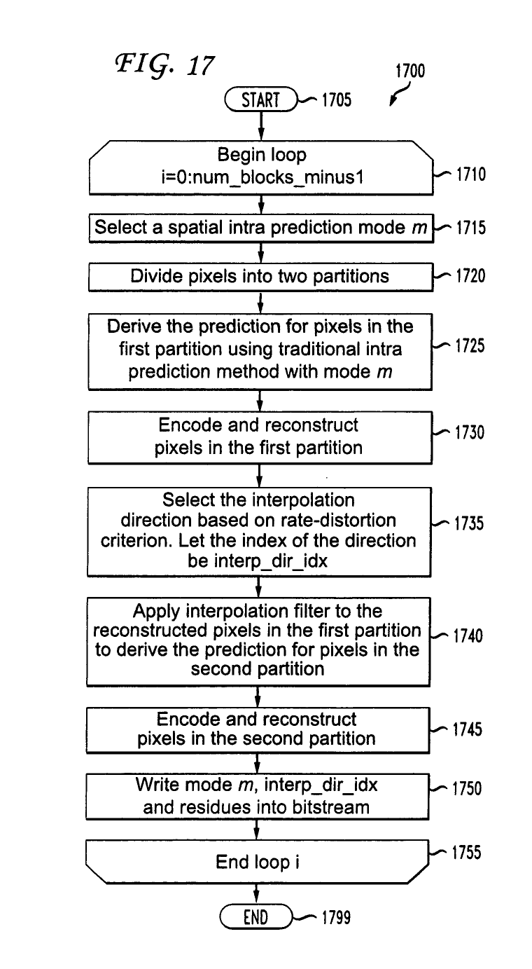

Turning to FIG. 17, yet another exemplary method for determining an interpolation direction in a video encoder is indicated generally by the reference numeral 1700. The method 1700 corresponds to Embodiment 3 relating to the interpolation direction. The method 1700 includes a start block 1705 that passes control to a loop limit block 1710. The loop limit block 1710 begins a loop using a variable i having a range from 0 to num_blocks_minus1, and passes control to a function block 1715. The function block 1715 selects a spatial intra prediction mode m, and passes control to a function block 1720. The function block 1720 divides pixels into two partitions, and passes control to a function block 1725. The function block 1725 derives the prediction for pixels in the first partition using the traditional intra prediction method with mode m, and passes control to a function block 1730. The function block 1730 encodes and reconstructs pixels in the first partition, and passes control to a function block 1735. The function block 1735 selects the interpolation direction based on rate-distortion criteria, lets the index of the direction be interp_dir_idx, and passes control to a function block 1740. The function block 1740 applies an interpolation filter to the reconstructed pixels in the first partition to derive the prediction for pixels in the second partition, and passes control to a function block 1745. The function block 1745 encodes and reconstructs pixels in the second partition, and passes control to a function block 1750. The function block 1750 writes mode m, interp_dir_idx, and the residues into a bitstream, and passes control to a loop limit block 1755. The loop limit block 1755 ends the loop, and passes control to an end block 1799.

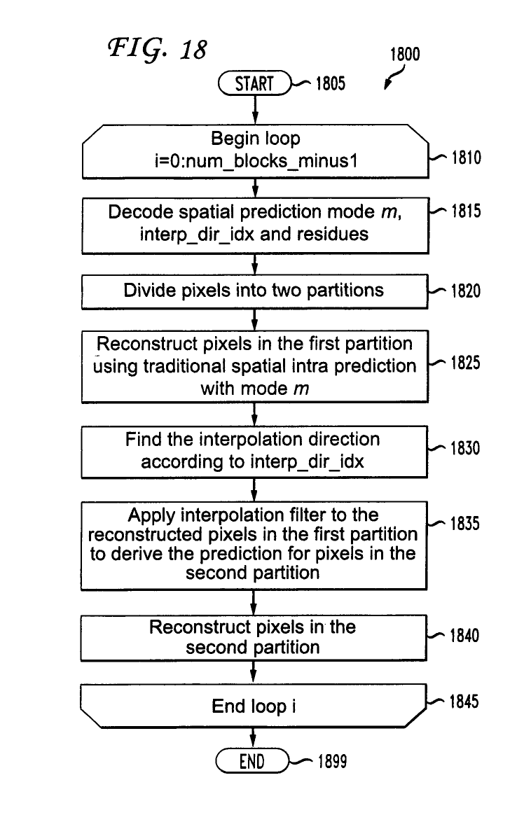

Turning to FIG. 18, yet another exemplary method for determining an interpolation direction in a video decoder is indicated generally by the reference numeral 1800. The method 1800 corresponds to Embodiment 3 relating to the interpolation direction. The method 1800 includes a start block 1805 that passes control to a loop limit block 1810. The loop limit block 1810 begins a loop using a variable i having a range from 0 to num_blocks_minus1, and passes control to a function block 1815. The function block 1815 decodes a spatial prediction mode m, interp_dir_idx, and residues, and passes control to a function block 1820. The function block 1820 divides pixels into two partitions, and passes control to a function block 1825. The function block 1825 reconstructs pixels in the first partition using traditional spatial intra prediction with mode m, and passes control to a function block 1830. The function block 1830 finds the interpolation direction according to inter_dir_idx, and passes control to a function block 1835. The function block 1835 applies an interpolation filter to the reconstructed pixels in the first partition to derive the prediction for pixels in the second partition, and passes control to a function block 1840. The function block 1840 reconstructs pixels in the second partition, and passes control to a loop limit block 1845. The loop limit block 1845 ends the loop, and passes control to an end block 1899.

### Interpolation Filters

In accordance with the present principles, and in a preferred embodiment, interpolation filters can be adaptively selected. The set of filters, and how the filter is selected, can be explicitly signaled or can be derived based on block size, spatial intra prediction mode m, pixel partition methods, interpolation direction, reconstructed pixels in the first partitions, and so forth, and/or based on the statistics of reconstructed pixels in the already decoded blocks, slices and/or frames

### Embodiment 1:

In Embodiment 1, a fixed filter is used in the interpolation process. The filter coefficients can be specified in a slice header, picture parameter set (PPS), sequence parameter set (SPS), and so forth. The decoder decodes the coefficients of the filter from the bit stream, and uses the filter to decode the block.

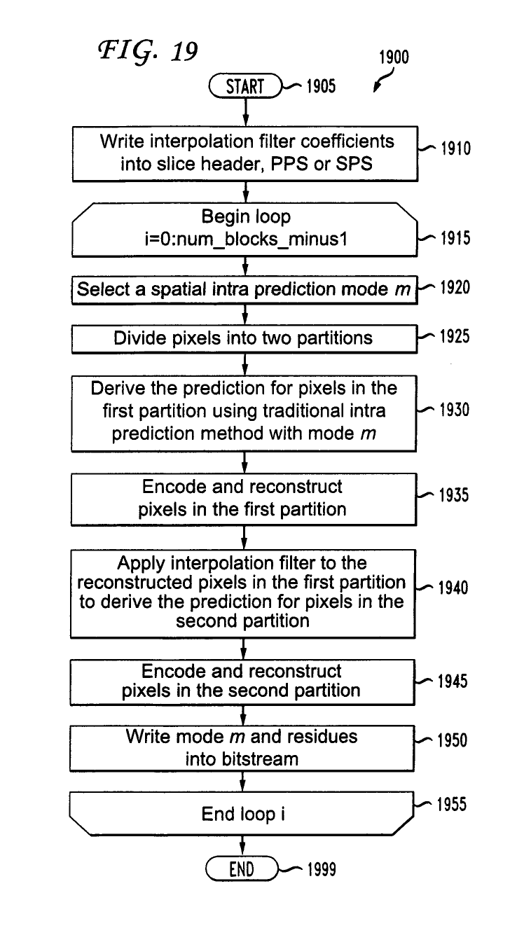

Turning to FIG. 19, an exemplary method for deriving an interpolation filter in a video encoder is indicated generally by the reference numeral 1900. The method 1900 corresponds to Embodiment 1 relating to the interpolation filter. The method 1900 includes a start block 1905 that passes control to a function block 1910. The function block 1910 writes interpolation filter coefficients into a slice header, picture parameter set (PPS), or sequence parameter set (SPS), and passes control to a loop limit block 1915. The loop limit block 1915 begins a loop using a variable i having a range from 0 to num_blocks_minus1, and passes control to a function block 1920. The function block 1920 selects a spatial intra prediction mode m, and passes control to a function block 1925. The function block 1925 divides pixels into two partitions, and passes control to a function block 1930. The function block 1930 derives the prediction for pixels in the first partition using the traditional intra prediction method with mode m, and passes control to a function block 1935. The function block 1935 encodes and reconstructs pixels in the first partition, and passes control to a function block 1940. The function block 1940 applies an interpolation filter to the reconstructed pixels in the first partition to derive the prediction for pixels in the second partition, and passes control to a function block 1945. The function block 1945 encodes and reconstructs pixels in the second partition, and passes control to a function block 1950. The function block 1950 writes mode m and the residues into a bitstream, and passes control to a loop limit block 1955. The loop limit block 1955 ends the loop, and passes control to an end block 1999.

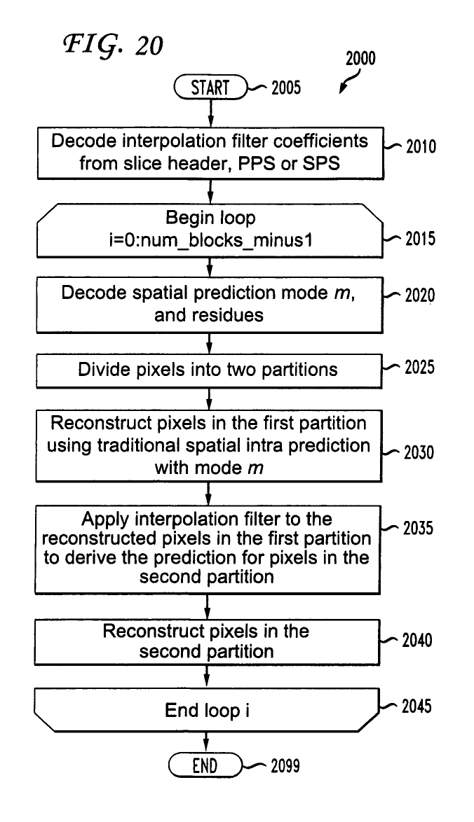

Turning to FIG. 20, an exemplary method for deriving an interpolation filter in a video decoder is indicated generally by the reference numeral 2000. The method 2000 corresponds to Embodiment 1 relating to the interpolation filter. The method 2000 includes a start block 2005 that passes control to a function block 2010. The function block 2010 decodes interpolation filter coefficients from a slice header, PPS, or SPS, and passes control to a loop limit block 2015. The loop limit block 2015 begins a loop using a variable i having a range from 0 to num_blocks_minus1, and passes control to a function block 2020. The function block 2020 decodes a spatial prediction mode m and residues, and passes control to a function block 2025. The function block 2025 divides pixels into two partitions, and passes control to a function block 2030. The function block 2030 reconstructs pixels in the first partition using traditional spatial intra prediction with mode m, and passes control to a function block 2035. The function block 2035 applies an interpolation filter to the reconstructed pixels in the first partition to derive the prediction for pixels in the second partition, and passes control to a function block 2040. The function block 2040 reconstructs pixels in the second partition, and passes control to a loop limit block 2045. The loop limit block 2045 ends the loop, and passes control to an end block 2099.

### Embodiment 2:

In Embodiment 2, a set of interpolation filters is defined. For one block, the encoder selects a filter from the set based on block size, spatial intra prediction mode m, pixel partition methods, interpolation direction, reconstructed pixels in the first partitions, and so forth. The same procedure is applied at the decoder.

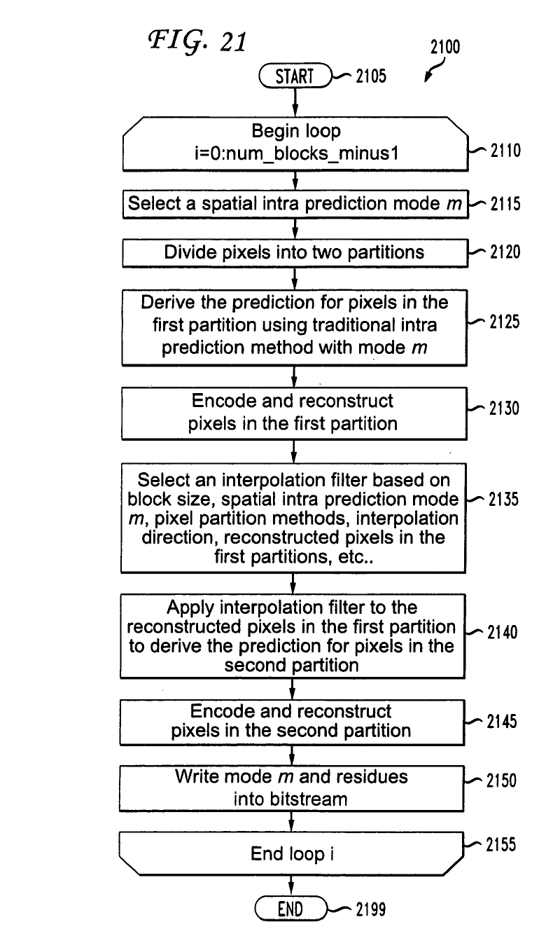

Turning to FIG. 21, another exemplary method for deriving an interpolation filter in a video encoder is indicated generally by the reference numeral 2100. The method 2100 corresponds to Embodiment 2 relating to the interpolation filter. The method 2100 includes a start block 2105 that passes control to a loop limit block 2110. The loop limit block 2110 begins a loop using a variable i having a range from 0 to num_blocks_minus1, and passes control to a function block 2115. The function block 2115 selects a spatial intra prediction mode m, and passes control to a function block 2120. The function block 2120 divides pixels into two partitions, and passes control to a function block 2125. The function block 2125 derives the prediction for pixels in the first partition using the traditional intra prediction method with mode m, and passes control to a function block 2130. The function block 2130 encodes and reconstructs pixels in the first partition, and passes control to a function block 2135. The function block 2135 selects an interpolation filter based on block size, spatial intra prediction mode m, pixel partition methods, interpolation direction, reconstructed pixels in the first partition, and so forth, and passes control to a function block 2140. The function block 2140 applies an interpolation filter to the reconstructed pixels in the first partition to derive the prediction for pixels in the second partition, and passes control to a function block 2145. The function block 2145 encodes and reconstructs pixels in the second partition, and passes control to a function block 2150. The function block 2150 writes mode m and the residues into a bitstream, and passes control to a loop limit block 2155. The loop limit block 2155 ends the loop, and passes control to an end block 2199.

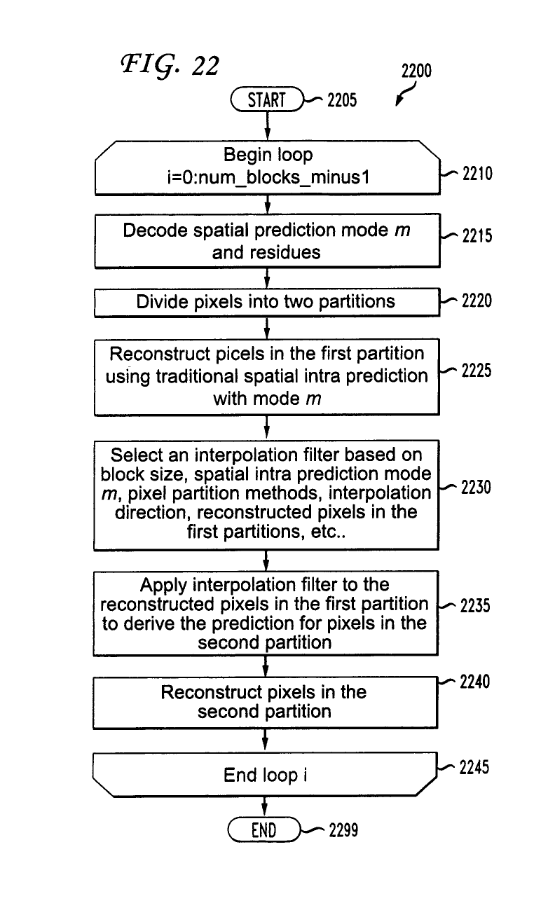

Turning to FIG. 22, another exemplary method for deriving an interpolation filter in a video decoder is indicated generally by the reference numeral 2200. The method 2200 corresponds to Embodiment 2 relating to the interpolation filter. The method 2200 includes a start block 2205 that passes control to a loop limit block 2210. The loop limit block 2210 begins a loop using a variable i having a range from 0 to num_blocks_minus1, and passes control to a function block 2215. The function block 2215 decodes a spatial prediction mode m and residues, and passes control to a function block 2220. The function block 2220 divides pixels into two partitions, and passes control to a function block 2225. The function block 2225 reconstructs pixels in the first partition using traditional spatial intra prediction with mode m, and passes control to a function block 2230. The function block 2230 selects an interpolation filter based on block size, spatial intra prediction mode m, pixel partition methods, interpolation direction, reconstructed pixels in the first partition, and so forth, and passes control to a function block 2235. The function block 2235 applies an interpolation filter to the reconstructed pixels in the first partition to derive the prediction for pixels in the second partition, and passes control to a function block 2240. The function block 2240 reconstructs pixels in the second partition, and passes control to a loop limit block 2245. The loop limit block 2245 ends the loop, and passes control to an end block 2299.

### Embodiment 3:

In Embodiment 3, a set of interpolation filters is defined. For one block, the encoder tests different interpolation filters, and selects the best one based on rate-distortion criterion. Let filter_idx be the index of the selected filter. The encoder sends the index filter_idx to the decoder to indicate its selection. The decoder decodes filter_idx and accordingly selects the interpolation filter for block decoding.

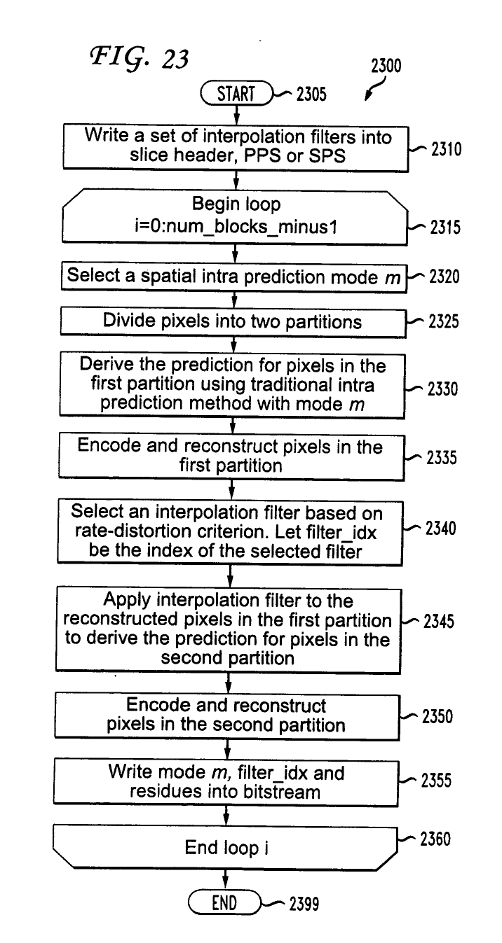

Turning to FIG. 23, yet another exemplary method for deriving an interpolation filter in a video encoder is indicated generally by the reference numeral 2300. The method 2300 corresponds to Embodiment 3 relating to the interpolation filter. The method 2300 includes a start block 2305 that passes control to a function block 2310. The function block 2310 writes a set of interpolation filters into a slice header, PPS, or SPS, and passes control to a loop limit block 2315. The loop limit block 2315 begins a loop using a variable i having a range from 0 to num_blocks_minus1, and passes control to a function block 2320. The function block 2320 selects a spatial intra prediction mode m, and passes control to a function block 2325. The function block 2325 divides pixels into two partitions, and passes control to a function block 2330. The function block 2330 derives the prediction for pixels in the first partition using the traditional intra prediction method with mode m, and passes control to a function block 2335. The function block 2335 encodes and reconstructs pixels in the first partition, and passes control to a function block 2340. The function block 2340 selects an interpolation filter based on rate-distortion criteria, lets filter_idx be the index of the selected filter, and passes control to a function block 2345. The function block 2345 applies an interpolation filter to the reconstructed pixels in the first partition to derive the prediction for pixels in the second partition, and passes control to a function block 2350. The function block 2350 encodes and reconstructs pixels in the second partition, and passes control to a function block 2355. The function block 2355 writes mode m, filter_idx, and the residues into a bitstream, and passes control to a loop limit block 2360. The loop limit block 2360 ends the loop, and passes control to an end block 2399.

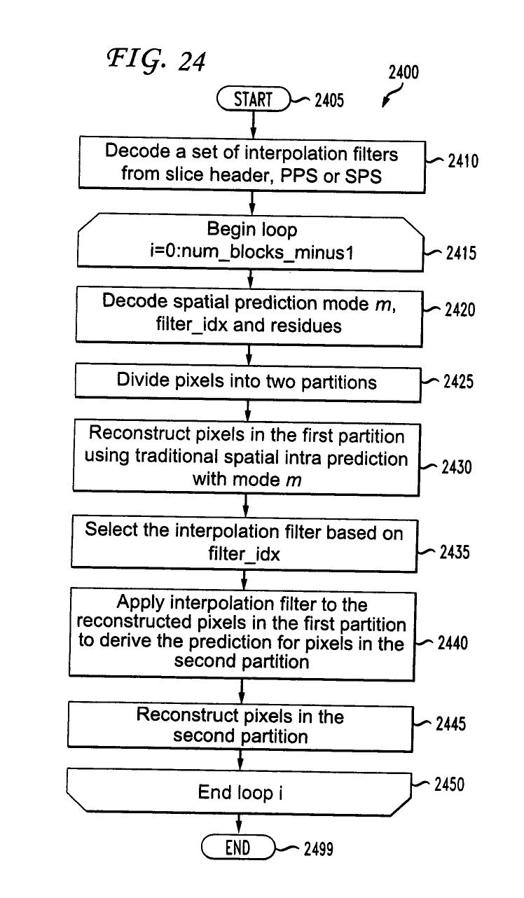

Turning to FIG. 24, yet another exemplary method for deriving an interpolation filter in a video decoder is indicated generally by the reference numeral 2400. The method 2400 corresponds to Embodiment 3 relating to the interpolation filter. The method 2400 includes a start block 2405 that passes control to a function block 2410. The function block 2410 decodes a set of interpolation filters from a slice header, PPS, or SPS, and passes control to a loop limit block 2415. The loop limit block 2415 begins a loop using a variable i having a range from 0 to num_blocks_minus1, and passes control to a function block 2420. The function block 2420 decodes a spatial prediction mode m, filter_idx, and residues, and passes control to a function block 2425. The function block 2425 divides pixels into two partitions, and passes control to a function block 2430. The function block 2430 reconstructs pixels in the first partition using traditional spatial intra prediction with mode m, and passes control to a function block 2435. The function block 2435 selects the interpolation filter based on filter_idx, and passes control to a function block 2440. The function block 2440 applies an interpolation filter to the reconstructed pixels in the first partition to derive the prediction for pixels in the second partition, and passes control to a function block 2445. The function block 2445 reconstructs pixels in the second partition, and passes control to a loop limit block 2450. The loop limit block 2450 ends the loop, and passes control to an end block 2499.

### Embodiment 4:

In Embodiment 4, the encoder derives the interpolation filter based on the statistics of reconstructed pixels in the already encoded or decoded blocks, slices and/or frames. The same procedure is applied at decoder.

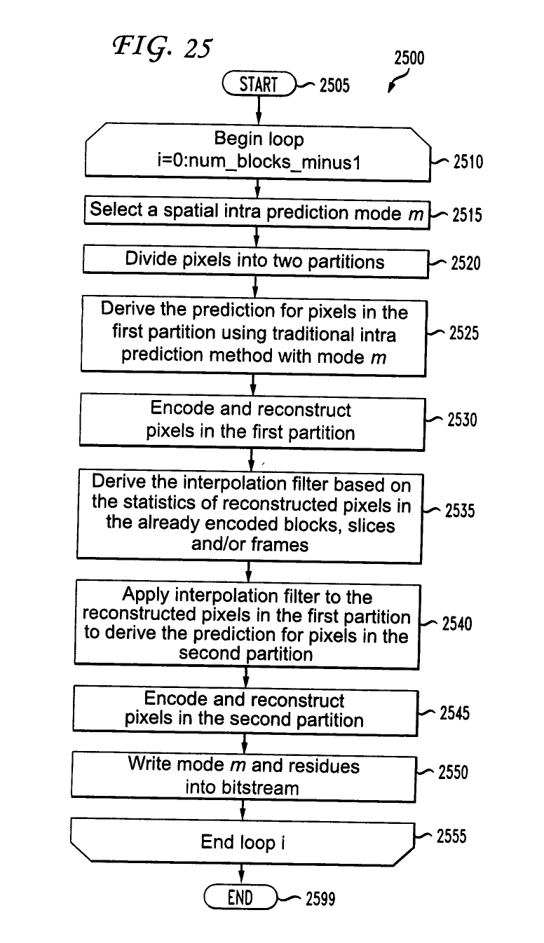

Turning to FIG. 25, still another exemplary method for deriving an interpolation filter in a video encoder is indicated generally by the reference numeral 2500. The method 2500 corresponds to Embodiment 4 relating to the interpolation filter. The method 2500 includes a start block 2505 that passes control to a loop limit block 2510. The loop limit block 2510 begins a loop using a variable i having a range from 0 to num_blocks_minus1, and passes control to a function block 2515. The function block 2515 selects a spatial intra prediction mode m, and passes control to a function block 2520. The function block 2520 divides pixels into two partitions, and passes control to a function block 2525. The function block 2525 derives the prediction for pixels in the first partition using the traditional intra prediction method with mode m, and passes control to a function block 2530. The function block 2530 encodes and reconstructs pixels in the first partition, and passes control to a function block 2535. The function block 2535 derives the interpolation filter based on statistics of reconstructed pixels in the already encoded blocks, slices and/or frames, and passes control to a function block 2540. The function block 2540 applies an interpolation filter to the reconstructed pixels in the first partition to derive the prediction for pixels in the second partition, and passes control to a function block 2545. The function block 2545 encodes and reconstructs pixels in the second partition, and passes control to a function block 2550. The function block 2550 writes mode m and the residues into a bitstream, and passes control to a loop limit block 2555. The loop limit block 2555 ends the loop, and passes control to an end block 2599.

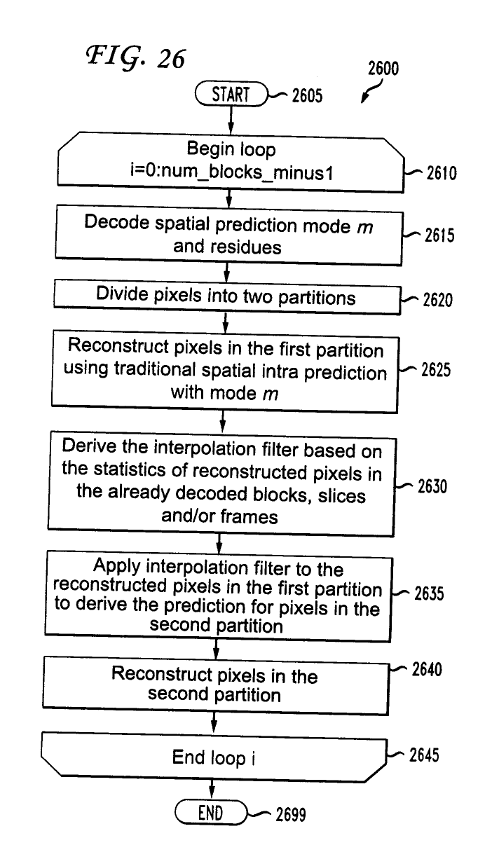

Turning to FIG. 26, still another exemplary method for deriving an interpolation filter in a video decoder is indicated generally by the reference numeral 2600. The method 2600 corresponds to Embodiment 4 relating to the interpolation filter. The method 2600 includes a start block 2605 that passes control to a loop limit block 2610. The loop limit block 2610 begins a loop using a variable i having a range from 0 to num_blocks_minus1, and passes control to a function block 2615. The function block 2615 decodes a spatial prediction mode m and residues, and passes control to a function block 2620. The function block 2620 divides pixels into two partitions, and passes control to a function block 2625. The function block 2625 reconstructs pixels in the first partition using traditional spatial intra prediction with mode m, and passes control to a function block 2630. The function block 2630 derives the interpolation filter based on statistics of reconstructed pixels in the already decoded blocks, slices, and/or frames, and passes control to a function block 2635. The function block 2635 applies an interpolation filter to the reconstructed pixels in the first partition to derive the prediction for pixels in the second partition, and passes control to a function block 2640. The function block 2640 reconstructs pixels in the second partition, and passes control to a loop limit block 2645. The loop limit block 2645 ends the loop, and passes control to an end block 2699.

### Syntax

We have presented several different embodiments and for different embodiments the syntax can be different.

TABLE 1 shows exemplary macroblock layer syntax for Embodiment 2 relating to the partition of pixels.

TABLE 1

| | |
|---|---|
| macroblock_layer( ) { | Descriptor |

```
  ....
  partition_idx
    ....
    }
```

The semantics of the syntax elements of TABLE 1 are as follows:
partition_idx=0 specifies that partition 1 includes all the pixels in odd rows (row 1, 3, . . . 2M-1), and partition 2 includes all the pixels in even columns (row 0, 2, . . . 2M-2).
partition_idx=1 specifies that partition 1 includes all the pixels in odd columns (column 1, 3, . . . 2N-1), and partition 2 includes all the pixels in even columns (column 0, 2, . . . 2N-2).
partition_idx=2 specifies that partition 1 includes all the pixels with coordinates (i,j), where (i+j) is an odd number, and partition 2 includes all the other pixels.

TABLE 2 shows exemplary macroblock layer syntax for Embodiment 3 relating to the interpolation direction.

TABLE 2

| | |
|---|---|
| macroblock_layer( ) { | Descriptor |

```
  ....
  interp_dir_idx
      ....
      }
```

The semantics of the syntax elements of TABLE 2 are as follows:

interp_dir_idx=0 specifies that horizontal interpolation.

interp_dir_idx=1 specifies vertical interpolation.

interp_dir_idx=2 specifies diagonal interpolation.

TABLE 3 shows exemplary macroblock layer syntax for Embodiment 3 relating to the interpolation filter.

TABLE 2

| | |
|---|---|
| macroblock_layer( ) { | Descriptor |

```
  ....
  filter_idx
      ....
      }
```

The semantics of the syntax elements of TABLE 2 are as follows:

filter_idx=0 specifies 2-tap simple average filter [1 1]/2.

filter_idx=1 specifies 6-tap wiener filter [1 −5 20 20 −5 1]/32.

A description will now be given of some of the many attendant advantages/features of the present invention, some of which have been mentioned above. For example, one advantage/feature is an apparatus having a video encoder for encoding at least an intra block in a picture by dividing the intra block into at least a first partition and a second partition, and generating predictions of pixels in the second partition by adaptively interpolating reconstructed pixels from the first partition.

Another advantage/feature is the apparatus having the video encoder as described above, wherein a partition method used to partition the intra block is based on an intra prediction mode.

Yet another advantage/feature is the apparatus having the video encoder as described above, wherein picture data for the intra block is encoded into a resultant bitstream, and a partition method used to partition the intra block is explicitly signaled in the resultant bitstream.

Still another advantage/feature is the apparatus having the video encoder as described above, wherein an interpolation direction used to adaptively interpolate the reconstructed pixels from the first partition is determined based on an intra prediction mode.

Still yet another advantage/feature is the apparatus having the video encoder as described above, wherein an interpolation direction used to adaptively interpolate the reconstructed pixels from the first partition is determined based on a partition method used to partition the intra block.

Moreover, another advantage/feature is the apparatus having the video encoder as described above, wherein picture data for the intra block is encoded into a resultant bitstream, and an interpolation direction used to adaptively interpolate the reconstructed pixels from the first partition is explicitly signaled in the resultant bitstream.

Further, another advantage/feature is the apparatus having the video encoder as described above, wherein picture data for the intra block is encoded into a resultant bitstream, and the apparatus further includes at least one adaptive interpolation filter for adaptively interpolating the reconstructed pixels from the first partition, the at least one adaptive interpolation filter being explicitly signaled in the resultant bitstream.

Also, another advantage/feature is the apparatus having the video encoder as described above, further including at least one adaptive interpolation filter for adaptively interpolating the reconstructed pixels from the first partition, the at least one adaptive interpolation filter being determined based on a size of the block, a spatial intra prediction mode, pixel partition methods, an interpolation direction, and the reconstructed pixels in the first partition.

Additionally, another advantage/feature is the apparatus having the video encoder as described above, wherein picture data for the intra block is encoded into a resultant bitstream, and the apparatus further includes a plurality of adaptive interpolation filters, the plurality of adaptive interpolation filters also being included in a corresponding decoder, and wherein a particular one of the plurality of adaptive interpolation filters selected for use by said video encoder in generating the predictions of the pixels in the second partition is explicitly signaled in the resultant bitstream.

Moreover, another advantage/feature is the apparatus having the video encoder as described above, further including at least one adaptive interpolation filter for adaptively interpolating the reconstructed pixels from the first partition, the at least one adaptive interpolation filter being derived based on statistics of reconstructed pixels in at least one of previously encoded blocks, slices, and pictures.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a video encoder for encoding at least an intra block in a picture by dividing the intra block into at least a first partition and a second partition, and generating predictions of pixels in the second partition by adaptively interpolating reconstructed pixels from the first partition.

2. The apparatus of claim 1, wherein a partition method used to partition the intra block is based on an intra prediction mode.

3. The apparatus of claim 1, wherein picture data for the intra block is encoded into a resultant bitstream, and a partition method used to partition the intra block is explicitly signaled in the resultant bitstream.

4. The apparatus of claim 1, wherein an interpolation direction used to adaptively interpolate the reconstructed pixels from the first partition is determined based on an intra prediction mode.

5. The apparatus of claim 1, wherein an interpolation direction used to adaptively interpolate the reconstructed pixels from the first partition is determined based on a partition method used to partition the intra block.

6. The apparatus of claim 1, wherein picture data for the intra block is encoded into a resultant bitstream, and an interpolation direction used to adaptively interpolate the reconstructed pixels from the first partition is explicitly signaled in the resultant bitstream.

7. The apparatus of claim 1, wherein picture data for the intra block is encoded into a resultant bitstream, and the apparatus further comprises at least one adaptive interpolation filter for adaptively interpolating the reconstructed pixels from the first partition, the at least one adaptive interpolation filter being explicitly signaled in the resultant bitstream.

8. The apparatus of claim 1, further comprising at least one adaptive interpolation filter for adaptively interpolating the reconstructed pixels from the first partition, the at least one adaptive interpolation filter being determined based on a size of the block, a spatial intra prediction mode, pixel partition methods, an interpolation direction, and the reconstructed pixels in the first partition.

9. The apparatus of claim 1, wherein picture data for the intra block is encoded into a resultant bitstream, and the apparatus further comprises a plurality of adaptive interpolation filters, the plurality of adaptive interpolation filters also being included in a corresponding decoder, and wherein a particular one of the plurality of adaptive interpolation filters selected for use by said video encoder in generating the predictions of the pixels in the second partition is explicitly signaled in the resultant bitstream.

10. The apparatus of claim 1, further comprising at least one adaptive interpolation filter for adaptively interpolating the reconstructed pixels from the first partition, the at least one adaptive interpolation filter being derived based on statistics of reconstructed pixels in at least one of previously encoded blocks, slices, and pictures.

11. In a video encoder, a method, comprising:
encoding at least an intra block in a picture by dividing the intra block into at least a first partition and a second partition, and generating predictions of pixels in the second partition by adaptively interpolating reconstructed pixels from the first partition.

12. The method of claim 11, wherein a partition method used to partition the intra block is based on an intra prediction mode.

13. The method of claim 11, wherein picture data for the intra block is encoded into a resultant bitstrearn, and a partition method used to partition the intra block is explicitly signaled in the resultant bitstream.

14. The method of claim 11, wherein an interpolation direction used to adaptively interpolate the reconstructed pixels from the first partition is determined based on an intra prediction mode.

15. The method of claim 11, wherein an interpolation direction used to adaptively interpolate the reconstructed pixels from the first partition is determined based on a partition method used to partition the intra block.

16. The method of claim 11, wherein picture data for the intra block is encoded into a resultant bitstream, and an interpolation direction used to adaptively interpolate the reconstructed pixels from the first partition is explicitly signaled in the resultant bitstream.

17. The method of claim 11, wherein picture data for the intra block is encoded into a resultant bitstream, and the method further comprises explicitly signaling in the resultant bitstream at least one adaptive interpolation filter used for adaptively interpolating the reconstructed pixels from the first partition.

18. The method of claim 11, wherein at least one adaptive interpolation filter for adaptively interpolating the reconstructed pixels from the first partition is determined based on a size of the block, a spatial intra prediction mode, pixel partition methods, an interpolation direction, and the reconstructed pixels in the first partition.

19. The method of claim 11, wherein picture data for the intra block is encoded into a resultant bitstream, and the method further comprises explicitly signaling in the resultant bitstream a particular one of a plurality of adaptive interpolation filters, the particular one of the plurality of adaptive interpolation filters being selected for use by said video encoder in generating the predictions of the pixels in the second partition, the plurality of adaptive interpolation filters being included in the video encoder and a corresponding decoder.

20. The method of claim 11, further comprising deriving at least one adaptive interpolation filter for adaptively interpolating the reconstructed pixels from the first partition based on statistics of reconstructed pixels in at least one of previously encoded blocks, slices, and pictures.

21. An apparatus, comprising:
a video decoder for decoding at least an intra block in a picture by dividing the intra block into at least a first partition and a second partition, and generating predictions of pixels in the second partition by adaptively interpolating reconstructed pixels from the first partition.

22. The apparatus of claim 21, wherein a partition method used to partition the intra block is based on an intra prediction mode.

23. The apparatus of claim 21, wherein picture data for the intra block is decoded from a bitstream, and a partition method used to partition the intra block is explicitly determined from the bitstream.

24. The apparatus of claim 21, wherein an interpolation direction used to adaptively interpolate the reconstructed pixels from the first partition is determined based on an intra prediction mode.

25. The apparatus of claim 21, wherein an interpolation direction used to adaptively interpolate the reconstructed pixels from the first partition is determined based on a partition method used to partition the intra block.

26. The apparatus of claim 21, wherein picture data for the intra block is decoded from a bitstream, and an interpolation direction used to adaptively interpolate the reconstructed pixels from the first partition is explicitly determined from the bitstream.

27. The apparatus of claim 21, wherein picture data for the intra block is decoded from a bitstream, and the apparatus further comprises at least one adaptive interpolation filter for adaptively interpolating the reconstructed pixels from the first partition, the at least one adaptive interpolation filter being explicitly determined from the bitstream.

28. The apparatus of claim 21, further comprising at least one adaptive interpolation filter for adaptively interpolating the reconstructed pixels from the first partition, the at least one adaptive interpolation filter being determined based on a size of the block, a spatial intra prediction mode, pixel partition methods, an interpolation direction, and the reconstructed pixels in the first partition.

29. The apparatus of claim 21, wherein picture data for the intra block is decoded from a bitstream, and the apparatus further comprises a plurality of adaptive interpolation filters, the plurality of adaptive interpolation filters also being included in a corresponding video encoder, and wherein a particular one of the plurality of adaptive interpolation filters selected for use by the corresponding video encoder in generating the predictions of the pixels in the second partition is explicitly determined from the bitstream.

30. The apparatus of claim 21, further comprising at least one adaptive interpolation filter for adaptively interpolating the reconstructed pixels from the first partition, the at least one adaptive interpolation filter being derived based on statistics of reconstructed pixels in at least one of previously decoded blocks, slices, and pictures.

31. In a video decoder, a method, comprising:
decoding at least an intra block in a picture by dividing the intra block into at least a first partition and a second partition, and generating predictions of pixels in the second partition by adaptively interpolating reconstructed pixels from the first partition.

32. The method of claim 31, wherein a partition method used to partition the intra block is based on an intra prediction mode.

33. The method of claim 31, wherein picture data for the intra block is decoded from a bitstream, and a partition method used to partition the intra block is explicitly determined from the bitstream.

34. The method of claim 31, wherein an interpolation direction used to adaptively interpolate the reconstructed pixels from the first partition is determined based on an intra prediction mode.

35. The method of claim 31, wherein an interpolation direction used to adaptively interpolate the reconstructed pixels from the first partition is determined based on a partition method used to partition the intra block.

36. The method of claim 31, wherein picture data for the intra block is decoded from a bitstream, and an interpolation direction used to adaptively interpolate the reconstructed pixels from the first partition is explicitly determined from the bitstream.

37. The method of claim 31, wherein picture data for the intra block is decoded from a bitstream, and the method further comprises explicitly determining from the bitstream at least one adaptive interpolation filter for adaptively interpolating the reconstructed pixels from the first partition.

38. The method of claim 31, further comprising determining at least one adaptive interpolation filter for adaptively interpolating the reconstructed pixels from the first partition based on a size of the block, a spatial intra prediction mode, pixel partition methods, an interpolation direction, and the reconstructed pixels in the first partition.

39. The method of claim 31, wherein picture data for the intra block is decoded from a bitstream, and the apparatus further comprises explicitly determining from the bitstream a particular one of a plurality of adaptive interpolation filters selected for use by a corresponding video encoder in generating the predictions of the pixels in the second partition, the plurality of adaptive interpolation filters being included in the video decoder and the corresponding video encoder.

40. The method of claim 31, further comprising deriving at least one adaptive interpolation filter for adaptively interpolating the reconstructed pixels from the first partition based on statistics of reconstructed pixels in at least one of previously decoded blocks, slices, and pictures.

41. A computer readable storage media having video signal data encoded thereupon, comprising:
at least an intra block in a picture encoded by dividing the intra block into at least a first partition and a second partition, and generating predictions of pixels in the second partition by adaptively interpolating reconstructed pixels from the first partition.
